(19) United States
(12) Patent Application Publication
(10) Pub. No.: US 2016/0075042 A1
(43) Pub. Date: Mar. 17, 2016

(54) SAFETY CUTTER FOR JAM PREVENTION

(71) Applicant: Sang-Keun OH, Gwancheon-shi (KR)

(72) Inventor: Sang Keun OH, Gwacheon-si (KR)

(21) Appl. No.: 14/786,727

(22) PCT Filed: Apr. 26, 2013
(86) PCT No.: PCT/KR2013/003631

§ 371 Date: Oct. 23, 2015

(51) Int. Cl. B26B 25/00; B26B 29/00

(52) U.S. Cl. CPC B26B 25/005; B26B 29/00

(57) ABSTRACT

A safety cutter for jam prevention for preventing an object being cut from being jammed when the direction of a disc-shaped rotary cutting member is switched especially in a diagonal or curved line, as well as cutting the object while the disc-shaped rotary cutting member is traversing and rotating about a center of the object being cut by means of simple pushing force without needing scissoring. The safety cutter includes a cutter body, disc-shaped rotary cutting members, and fastening members. In the cutter body, an open slit is formed on the front of the cutter body, coupling holes are respectively formed on the top and bottom of the open slit, and a grip part is formed on the rear of the cutter body.

### RELATED APPLICATIONS

This application is a U.S. national stage application under 35 U.S.C. §371 of PCT International Application Serial No. PCT/KR2013/003631, which has an international filing date of Apr. 26, 2013, designates the United States of America, and which is hereby expressly incorporated by reference in its entirety.

### FIELD OF THE DISCLOSURE

The present disclosure relates to a cutter for cutting an object such as paper, film, fabric, etc. and, more particularly, to an anti-jam safety cutter which is configured such that disc-shaped rotary cutting members are rotated across the center of an object to be cut by a simple pushing force without having to perform scissoring so as to rapidly, easily, and safely cut the object and is further configured such that the object to be cut is prevented from being jammed when the cutting direction of the disc-shaped rotary cutting members is changed in a diagonal or curved line.

### BACKGROUND

Scissors, one of the primary tools used to cut an object such as paper, film, fabric, etc., refer to a tool in which two scissor members, each having a cutting blade formed on one side and a finger insertion ring formed on the other side, cross each other and then their centers are fastened by a fastening member such as a pivot pin such that both cutting blades are engaged to cut the object, while the two scissor members having the cutting blades open and close using the lever principle.

However, when a user wants to cut an object such as paper, film, fabric, etc. using conventional scissors, the user should continue to scissor by opening and closing the two scissor members in a state where two fingers including a thumb are inserted into the finger insertion rings, which requires a long time, and when the user continues to scissor for a long time scissoring, the user has pain in the fingers and as well as has accumulated fatigue.

Moreover, the cutting blades formed on the two scissor members of the conventional scissors are exposed to the environment, which may cause safety problems, that is, when a child or student uses the scissors, he or she may get a cut on the finger from the blade through carelessness, and it is very inconvenient to carry it in his or her pocket.

A knife, another one of the primary tools used to cut an object such as paper, film, fabric, etc., is used to cut the object by moving a cutting blade in a state where the object is supported on the floor surface, and thus the floor surface is damaged by the cutting blade. Moreover, the cutting blade is exposed to the environment, which may cause safety problems, that is, when a child or student uses the knife, he or she may get a cut on the finger from the blade through carelessness, and the knife may also be used as a tool to cause serious bodily harm to any person and thus has been classified as a dangerous thing.

A variety of cutting tools have recently been developed to safely and conveniently cut an object such as paper, film, fabric, etc. by crossing the center of the object; however, these cutting tools are problematic in that further cutting is not made smoothly by the objects already cut, and in particular, the cutting is not achieved well when the cutting direction is changed in a diagonal or curved line.

Particularly, in the case of a cutter where the cutting means is formed with disc-shaped rotary cutting members, the disc-shaped rotary cutting members are rotatably connected to a cutter body by a fastening member such as a rivet. In this case, when the cutting direction is changed in a diagonal or curved line, the objects cut by the disc-shaped rotary cutting members interrupt the change of direction. Furthermore, a head portion of the fastening member for rotatably connecting the disc-shaped rotary cutting members to the cutter body is located on the outer surface thereof, and thus when the cutting direction is changed in a diagonal or curved line, the objects cut by the disc-shaped rotary cutting members may be jammed in a gap between the disc-shaped rotary cutting members and the head portion of the fastening member, which is problematic.

### SUMMARY

The present disclosure provides an anti-jam safety cutter which is configured such that disc-shaped rotary cutting members are rotated across the center of an object to be cut by a simple pushing force without having to perform scissoring so as to rapidly, easily, and safely cut the object and is further configured such that the object to be cut is prevented from being jammed when the cutting direction of the disc-shaped rotary cutting members is changed in a diagonal or curved line.

This may be achieved by providing an anti-jam safety cutter comprising: a cutter body which includes an open slit formed in the front thereof, coupling holes formed at the top and bottom of the open slit, respectively, and a grip portion provided at the rear thereof; disc-shaped rotary cutting members which are rotatably connected to the top and bottom of the front of the cutter body, respectively, and which include central holes formed in the center thereof to communicate with the coupling holes of the cutter body, insertion holes spaced in the radial direction from the central holes, and cutting blades formed on the edges thereof to protrude through the open slit and overlap each other; and fastening members which rotatably connect the disc-shaped rotary cutting members to the top and bottom of the front of the cutter body, respectively, and which include central coupling protrusions provided in the center thereof to be sequentially inserted and coupled to the central holes of the disc-shaped rotary cutting members and the coupling holes of the cutter body, and anti-jam insertion protrusions provided at the outside in the radial direction to be inserted and fixed to the insertion holes of the disc-shaped rotary cutting members to prevent an object to be cut from being jammed when the cutting direction is changed.

According to an embodiment of the present disclosure, the anti-jam safety cutter further comprises stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

According to another embodiment of the present disclosure, the central coupling protrusions of the fastening members have a “cross (+)” shape so as to exert their elasticity.

According to an embodiment of the present disclosure, the insertion holes of the disc-shaped rotary cutting members is provided at angular intervals of 90 degrees, and the anti-jam insertion protrusions of the fastening members are provided at angular intervals of 90 degrees to match the insertion holes.

Moreover, the above-described embodiment of the present disclosure is achieved by providing an anti-jam safety cutter comprising: a cutter body which includes an open slit formed in the front thereof, central rotation axes provided at the top and bottom of the open slit, respectively, and a grip portion provided at the rear thereof; and disc-shaped rotary cutting members which are inserted into the central rotation axes provided in the cutter body, respectively, and rotatably connected thereto and which include cutting blades formed on the edges thereof to protrude through the open slit and overlap each other.

According to one embodiment of the present disclosure, the anti-jam safety cutter further comprises stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

According to a further embodiment of the present disclosure, the anti-jam safety cutter further comprises an additional handle member including an insertion groove formed in the front thereof, into which the grip portion is inserted and connected.

According to a different embodiment of the present disclosure, the cutter body comprises first and second cutter body members of the same shape, which face each other and are connected with each other, wherein an open portion which narrows inwardly is formed in the front thereof to be biased downward past the center line, the central rotation axis is formed to protrude from the inner surface thereof below the open portion, a coupling groove into which an end of the central rotation axis is inserted is formed above the open portion, and a receiving groove for the disc-shaped rotary cutting member is formed around the central rotation axis and the coupling groove, and wherein the open slit of the cutter body is formed by intersection of the open portions when the first and second cutter body members are connected with each other.

According to a further embodiment of the present disclosure, a leaf spring for adjusting the length of the additional handle member inserted into the insertion groove is provided at one side of the grip portion of the cutter body.

Furthermore, another embodiment of the present disclosure is achieved by providing an anti-jam safety cutter comprising: a cutter body which includes an open slit formed in the front thereof, coupling holes formed at the top and bottom of the open slit, respectively, and a grip portion provided at the rear thereof; rotary couplers which are rotatably connected to the coupling holes of the cutter body, respectively; and disc-shaped rotary cutting members of which each center is integrally coupled to one side of each of the rotary couplers and which include cutting blades formed on the edges of the disc-shaped rotary cutting members to protrude through the open slit and overlap each other.

According to an embodiment of the present disclosure, the anti-jam safety cutter further comprises stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

According to a further embodiment of the present disclosure, the rotary couplers and the disc-shaped rotary cutting members are made of metal materials and the center of each of the disc-shaped rotary cutting members is integrally coupled to one side of each of the rotary couplers by welding.

In addition, the aforementioned embodiment is achieved by providing an anti-jam safety cutter comprising: a cutter body which includes an open slit formed in the front thereof; first and second receiving grooves formed to correspond to each other on the inner wall at the top and bottom of the open slit, respectively, and a grip portion provided at the rear thereof; rotation axes of which both ends are rotatably connected to the first and second receiving grooves of the cutter body, respectively, and each formed integrally with a support disc; and disc-shaped rotary cutting members which are inserted into the rotation axes to be in surface contact with the support discs and which include cutting blades formed on the edges thereof to protrude through the open slit and overlap each other, wherein the first receiving groove of the cutter body is formed as a two-stepped groove, with which one end of the rotation axis is in surface contact and in which the support disc is received, wherein a circular protrusion, which is in surface contact with the other side of the rotation axis, is provided on the circumference of the second receiving groove of the cutter body such that the other end of the rotation axis is kept spaced within the second receiving groove, and wherein the circular protrusion has an outer diameter smaller than that of the support disc.

According to another embodiment of the present disclosure, the anti-jam safety cutter further comprises stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

According to a further embodiment of the present disclosure, the cutter body comprises first and second cutter body members of the same shape, which face each other and are connected with each other, wherein an open portion which narrows inwardly is formed in the front thereof to be biased downward past the center line, the first receiving groove is formed on the inner surface thereof above the open portion, and the second receiving groove is formed below the open portion, and wherein the open slit of the cutter body is formed by intersection of the open portions when the first and second cutter body members are connected with each other.

According to yet a further embodiment of the present disclosure, the open portions of the first and second cutter body members comprise a plurality of obtusely-bent portions or round portions such that an object to be cut, which is brought into close contact with the open portions when the cutting direction is changed, can be naturally bent.

According to another embodiment of the present disclosure, a multi-stepped portion, which is lowered from the plurality of obtusely-bent portions or round portions, is formed on the outer surface of the open portions of the first and second cutter body members, respectively, such that the object, which is brought into close contact with the open portions when the cutting direction is changed, can be naturally bent.

Additionally, the above-described embodiment of the present disclosure is achieved by providing an anti-jam safety cutter comprising: a cutter body which includes an open slit formed in the front thereof, receiving grooves and central axes formed to correspond to each other on the inner wall at the top and bottom of the open slit, respectively, and a grip portion provided at the rear thereof; rotary discs which are received in the receiving grooves of the cutter body and each includes a coupling protrusion having a central axis through hole; and disc-shaped rotary cutting members which are inserted into the coupling protrusions of the rotary discs such that one side of each of the disc-shaped rotary cutting members is in surface contact with the rotary disc and which include cutting blades formed on the edges thereof to protrude through the open slit and overlap each other, wherein a central axis coupling hole, to which the central axis is connected, is formed in the receiving groove of the cutter body, and wherein a disc-shaped support protrusion, which is in surface contact with the other side of the disc-shaped rotary cutting member and has an outer diameter smaller than that of the rotary disc, is integrally provided at the bottom of the central axis.

According to one embodiment of the present disclosure, the anti-jam safety cutter further comprises stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

According to another embodiment of the present disclosure, the cutter body comprises first and second cutter body members of the same shape, which face each other and are connected with each other, wherein an open portion which narrows inwardly is formed in the front thereof to be biased downward past the center line, the receiving groove is formed on the inner surface thereof above the open portion, and the central axis is formed below the open portion, and wherein the open slit of the cutter body is formed by intersection of the open portions when the first and second cutter body members are connected with each other.

According to a further embodiment of the present disclosure, the open portions of the first and second cutter body members comprise a plurality of obtusely-bent portions or round portions such that an object to be cut, which is brought into close contact with the open portions when the cutting direction is changed, can be naturally bent.

According to yet a further embodiment of the present disclosure, a multi-stepped portion, which is lowered from the plurality of obtusely-bent portions or round portions, is formed on the outer surface of the open portions of the first and second cutter body members, respectively, such that the object, which is brought into close contact with the open portions when the cutting direction is changed, can be naturally bent.

According to another embodiment of the present disclosure, when a user grips the grip portion of the cutter body, inserts an object to be cut into the open slit, and then pushes the cutter body forward, the disc-shaped rotary cutting members are rotated across the center of the object by friction due to the object so as to rapidly, easily, and safely cut the object without having to perform scissoring.

In particular, according to the anti-jam safety cutter of the present disclosure, the anti-jam insertion protrusions of the fastening members are inserted and fixed to the insertion holes of the disc-shaped rotary cutting members to prevent the formation of a gap between the disc-shaped rotary cutting members and the fastening members, the disc-shaped rotary cutting members are inserted into the central rotation axes provided in the cutter body and rotatably connected thereto without any fastening members of which head portions protrude from the outer surface thereof, or the center of each of the disc-shaped rotary cutting members is integrally coupled by welding, for example, to the rotary couplers rotatably connected to the coupling holes and is rotated together without any fastening members of which head portions protrude from the outer surface thereof, and thus it is possible to prevent the object cut by the disc-shaped rotary cutting members from being jammed in a gap between the disc-shaped rotary cutting members and the head portions of the fastening members, which protrude from the outer surface thereof, even when the cutting direction of the disc-shaped rotary cutting members is changed in a diagonal or curved line. As a result, the change of direction to the diagonal and curved lines as well as the straight line can be made quite freely.

Moreover, according to the anti-jam safety cutter of the present disclosure, the cutting blades of the disc-shaped rotary cutting members are exposed within the open slit only, and thus it is possible to prevent the occurrence of safety accidents such as injury caused by the cutting blades.

Furthermore, according to the anti-jam safety cutter of the present disclosure, the stepped portions are stepped from the rear end of the open slit to both sides of the cutter body, and thus it is possible to easily separate and discharge both sides of the object cut by the disc-shaped rotary cutting members, which enables the cutting operation to be rapidly and easily performed.

### BRIEF DESCRIPTION OF DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a perspective view of an anti-jam safety cutter in accordance with a first embodiment of the present disclosure;

FIG. 2 is an exploded perspective view of the anti-jam safety cutter in accordance with the first embodiment of the present disclosure;

FIG. 3 is an operational view of the anti-jam safety cutter in accordance with the first embodiment of the present disclosure;

FIG. 4 is a perspective view of an anti-jam safety cutter in accordance with a second embodiment of the present disclosure;

FIG. 5 is an exploded perspective view of the anti-jam safety cutter in accordance with the second embodiment of the present disclosure;

FIG. 6 is an operational view of the anti-jam safety cutter in accordance with the second embodiment of the present disclosure;

FIG. 7 is a perspective view of an anti-jam safety cutter in accordance with a third embodiment of the present disclosure;

FIG. 8 is an exploded perspective view of the anti-jam safety cutter in accordance with the third embodiment of the present disclosure;

FIG. 9 is an operational view of the anti-jam safety cutter in accordance with the third embodiment of the present disclosure;

FIG. 10 is a perspective view of an anti-jam safety cutter in accordance with a fourth embodiment of the present disclosure;

FIG. 11 is an exploded perspective view of the anti-jam safety cutter in accordance with the fourth embodiment of the present disclosure;

FIG. 12 is a partial cross-sectional view of the anti-jam safety cutter in accordance with the fourth embodiment of the present disclosure;

FIG. 13 is an operational view of the anti-jam safety cutter in accordance with the fourth embodiment of the present disclosure;

FIG. 14 is a perspective view of an anti-jam safety cutter in accordance with a fifth embodiment of the present disclosure;

FIG. 15 is an exploded perspective view of the anti-jam safety cutter in accordance with the fifth embodiment of the present disclosure;

FIG. 16 is a partial cross-sectional view of the anti-jam safety cutter in accordance with the fifth embodiment of the present disclosure; and

FIG. 17 is an operational view of the anti-jam safety cutter in accordance with the fifth embodiment of the present disclosure.

### DETAILED DESCRIPTION

Hereinafter, preferred embodiments of the present disclosure will be described with reference to the accompanying drawings. The preferred embodiments are provided so that those skilled in the art can sufficiently understand the present disclosure, but can be modified in various forms and the scope of the present disclosure is not limited to the preferred embodiments.

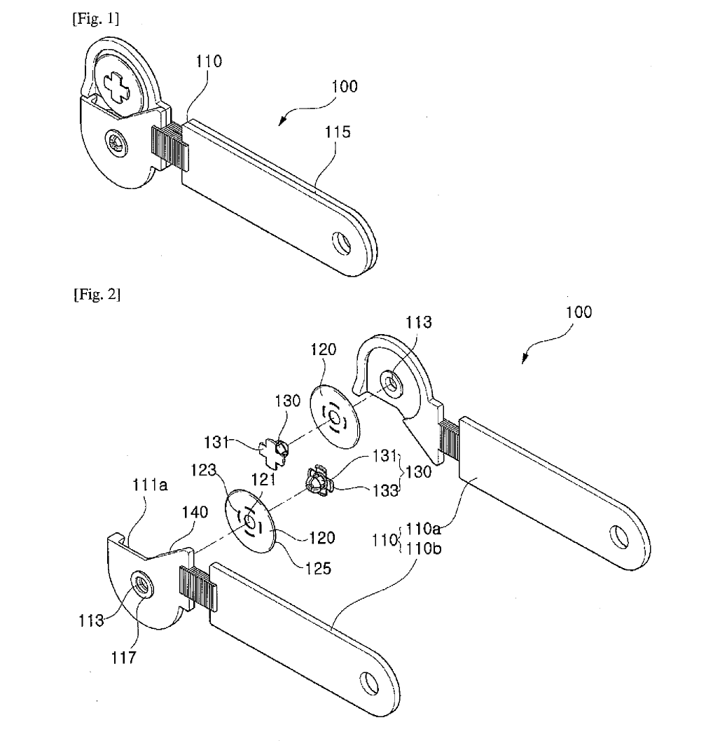

An anti-jam safety cutter 100 in accordance with a first embodiment of the present disclosure is configured such that disc-shaped rotary cutting members 120 are rotated across the center of an object 3 to be cut by a simple pushing force without having to perform scissoring so as to rapidly, easily, and safely cut the object 3 and is further configured such that the object 3 to be cut is prevented from being jammed when the cutting direction of the disc-shaped rotary cutting members 120 is changed in a diagonal or curved line. As shown in FIGS. 1 to 3, the anti-jam safety cutter 100 in accordance with the first embodiment of the present disclosure comprises: a cutter body 110 which includes an open slit 111 formed in the front thereof, coupling holes 113 formed at the top and bottom of the open slit 111, respectively, and a grip portion 115 provided at the rear thereof; fastening members 130 which rotatably connect the disc-shaped rotary cutting members 120 to the top and bottom of the front of the cutter body 110, respectively, and which include central coupling protrusions 131 provided in the center thereof to be sequentially inserted and coupled to the central holes 121 of the disc-shaped rotary cutting members 120 and the coupling holes 113 of the cutter body 110, and anti-jam insertion protrusions 133 provided at the outside in the radial direction to be inserted and fixed to the insertion holes 123 of the disc-shaped rotary cutting members 120 to prevent an object 3 to be cut from being jammed when the cutting direction is changed.

Here, the cutter body 110 is to form a frame for installation of the disc-shaped rotary cutting members 120, in which the open slit 111 is formed in the front thereof, through which the object 3 to be cut such as paper, film, fabric, etc. is fed, the coupling holes 113 are formed at the top and bottom of the open slit 111, respectively, for rotatable connection of the disc-shaped rotary cutting members 120, and the grip portion 115 is provided at the rear thereof for gripping by a user.

The cutter body 110 comprises first and second cutter body members 110a and 110b of the same shape, which face each other and are connected with each other. In the first and second cutter body members 110a and 110b, the coupling hole 113 is formed in the center of one side thereof when viewed from the outside, straight extension portions 111a are formed at the top of the coupling holes 113 to form the open slit 111 when the first and second cutter body members 110a and 110b are connected with each other, stepped portions for separation and discharge 140, which will be described later, are formed at the end of the straight extension portions 111a, respectively, and the portion extending from the other side forms the grip portion 115 when the first and second cutter body members 110a and 110b are connected with each other. The open slit 111 of the cutter body 110 is formed as the straight extension portions 111a are spaced from each other and extend in parallel to each other when the first and second cutter body members 110a and 110b are connected with each other.

The disc-shaped rotary cutting members 120 are rotatably connected to the coupling holes 113 at the top and bottom of the front of the above-described cutter body 110, respectively. When a user grips the grip portion 115 of the cutter body 110, inserts an object 3 to be cut into the open slit 111, and then pushes the cutter body 110 forward, the object 3 is fed between the cutting blades 125 of the disc-shaped rotary cutting members 120, which protrude through the open slit 111 and overlap each other, and the cutting blades 125 are automatically rotated by friction to cut the object 3.

The central holes 121 are formed in the center of the disc-shaped rotary cutting members 120 to communicate with the coupling holes 113 of the cutter body 110, and thus the disc-shaped rotary cutting members 120 can be rotatably connected to the cutter body 110 by the fastening members 130 which will be described in detail later.

Moreover, the insertion holes 123 are spaced in the radial direction from the central holes 121, and the anti-jam insertion protrusions 133 of the fastening members 130, which will be described in detail later, are inserted and fixed to the insertion holes 123. It is preferred that a total of four insertion holes 123 are formed at angular intervals of 90 degrees.

The cutting blades 125 are formed on the edges of the disc-shaped rotary cutting members 120 to protrude through the open slit 111 and overlap each other, and thus when the object 3 to be cut is fed therebetween, the cutting blades 125 are automatically rotated by friction to cut the object 3.

The above-described disc-shaped rotary cutting members 120 are rotatably connected to the top and bottom of the front of the cutter body 110 by the fastening members 130. To this end, the central coupling protrusions 131 are provided in the center of the fastening members 130 to be sequentially inserted and coupled to the central holes 121 of the disc-shaped rotary cutting members 120 and the coupling holes 113 of the cutter body 110, and the anti-jam insertion protrusions 133 are formed at the outside in the radial direction to be inserted and fixed to the insertion holes 123 of the disc-shaped rotary cutting members 120 to prevent the object 3 to be cut from being jammed when the cutting direction is changed.

It is preferred that the central coupling protrusions 131 of the fastening members 130 have a “cross (+)” shape so as to be sequentially inserted and easily coupled to the central holes 121 of the disc-shaped rotary cutting members 120 and the coupling holes 113 of the cutter body 110 and exert their elasticity during assembly.

Moreover, in order for the fastening members 130 not to be arbitrarily separated by an external force after assembly, it is preferred that a ring-shaped protection protrusion 117 is formed on the outer surface of the cutter body 110 to protrude from the circumference of each of the coupling holes 113 so as to surround the central coupling protrusion 131 protruding through the central hole 121 of the disc-shaped rotary cutting member 120.

Furthermore, the anti-jam insertion protrusions 133 are inserted and fixed to the insertion holes 123 of the disc-shaped rotary cutting members 120 to prevent the formation of a gap between the disc-shaped rotary cutting members 120 and the fastening members 130, thus preventing the object 3 to be cut from being jammed in a gap between the disc-shaped rotary cutting members 120 and the fastening members 130 when the cutting direction is changed. It is preferred that a total of four anti-jam insertion protrusions 133 are formed at angular intervals of 90 degrees to match the insertion holes 123 of the disc-shaped rotary cutting member 120.

The stepped portions for separation and discharge 140 are formed on both sides of the above-described cutter body 110 to guide the object 3, which is fed into the open slit 111 and cut into both sides by the disc-shaped rotary cutting members 120, such that both sides are separated from each other and discharged to the outside. The stepped portions 140 are stepped from the rear end of the open slit 111 to both sides of the cutter body 110.

As shown in the figures, the stepped portions 140 may extend obliquely upward from the rear end of the open slit 111 at one side of the cutter body 110 and extend obliquely downward from the rear end of the open slit 111 at the other side of the cutter body 110. Moreover, although not shown in the figures, the stepped portions 140 may extend to be bent obliquely upward from the rear end of the open slit 111 at one side of the cutter body 110 and extend to be bent obliquely downward from the rear end of the open slit 111 at the other side of the cutter body 110.

Furthermore, although not shown in the figures, it is preferred that an inclined surface is formed at the side of the stepped portion 140, and the inclined surface reduces the thickness of the cutter body 110 in the area of the stepped portion 140 and thus serves to guide the object 3, which is fed into the open slit 111 and cut into both sides by the disc-shaped rotary cutting members 120, such that both sides are not caught by the stepped portions 140 so as to prevent the occurrence of cutting failure and, at the same time, guide both sides of the cut object 3 to be naturally separated and discharged through the stepped portions 140.

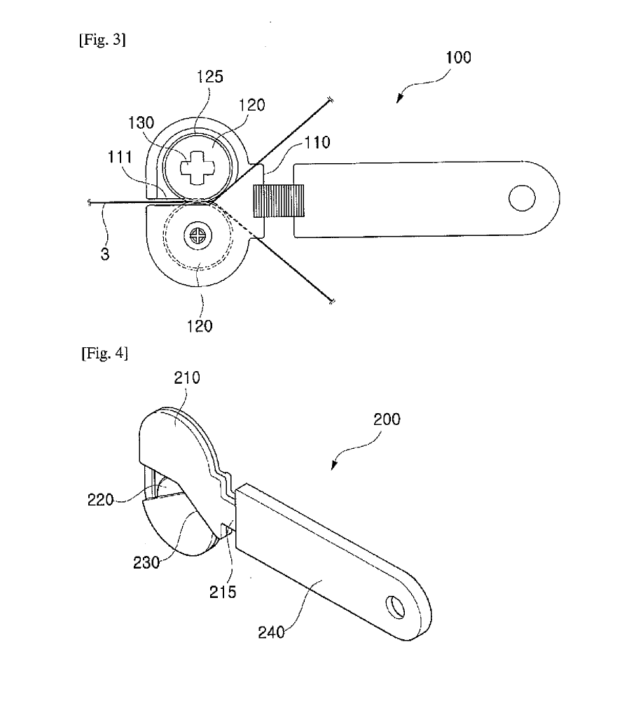

With the use of the above-described anti-jam safety cutter 100 in accordance with the first embodiment of the present disclosure, when a user grips the grip portion 115 of the cutter body 110, inserts an object 3 to be cut into the open slit 111, and then pushes the cutter body 110 forward, the disc-shaped rotary cutting members 120 are rotated across the center of the object 3 by friction due to the object 3 so as to rapidly, easily, and safely cut the object 3 without having to perform scissoring, as shown in FIG. 3.

Particularly, in the case of the anti-jam safety cutter 100 in accordance with the first embodiment of the present disclosure, the anti-jam insertion protrusions 133 of the fastening members 130 are inserted and fixed to the insertion holes 123 of the disc-shaped rotary cutting members 120 to prevent the formation of a gap between the disc-shaped rotary cutting members 120 and the fastening members 130, and thus it is possible to prevent the object 3 cut by the disc-shaped rotary cutting members 120 from being jammed in a gap between the disc-shaped rotary cutting members 120 and the head portions of the fastening members 130, which protrude from the outer surface thereof, even when the cutting direction of the disc-shaped rotary cutting members 120 is changed in a diagonal or curved line. As a result, the change of direction to the diagonal and curved lines as well as the straight line can be made quite freely.

Moreover, in the case of the anti-jam safety cutter 100 in accordance with the first embodiment of the present disclosure, the cutting blades 125 of the disc-shaped rotary cutting members 120 are exposed within the open slit 111 only, and thus it is possible to prevent the occurrence of safety accidents such as injury caused by the cutting blades 125. Furthermore, the stepped portions 140 are stepped from the rear end of the open slit 111 to both sides of the cutter body 110, and thus it is possible to easily separate and discharge both sides of the object 3 cut by the disc-shaped rotary cutting members 120, which enables the cutting operation to be rapidly and easily performed.

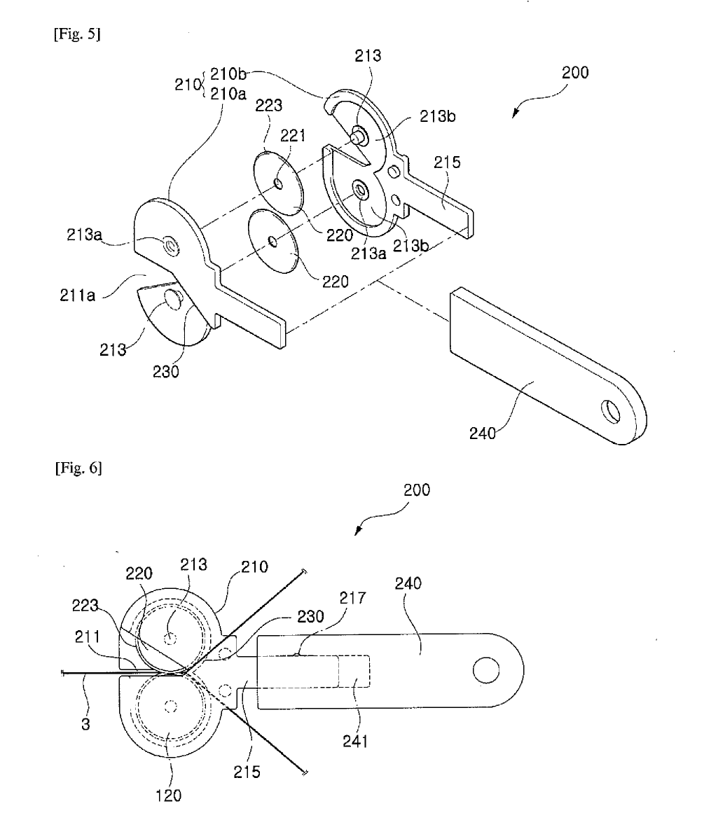

An anti-jam safety cutter 200 in accordance with a second embodiment of the present disclosure is configured such that disc-shaped rotary cutting members 220 are rotated across the center of an object 3 to be cut by a simple pushing force without having to perform scissoring so as to rapidly, easily, and safely cut the object 3 and is further configured such that the object 3 to be cut is prevented from being jammed when the cutting direction of the disc-shaped rotary cutting members 220 is changed in a diagonal or curved line. As shown in FIGS. 4 to 6, the anti-jam safety cutter 200 in accordance with the second embodiment of the present disclosure comprises: a cutter body 210 which includes an open slit 211 formed in the front thereof, central rotation axes 213 provided at the top and bottom of the open slit 211, respectively, and a grip portion 215 provided at the rear thereof; and disc-shaped rotary cutting members 220 which are inserted into the central rotation axes 213 provided in the cutter body 210, respectively, and rotatably connected thereto and which include cutting blades 223 formed on the edges thereof to protrude through the open slit 211 and overlap each other.

The cutter body 210 is to form a frame for installation of the disc-shaped rotary cutting members 220, in which the open slit 211 is formed in the front thereof, through which the object 3 to be cut such as paper, film, fabric, etc. is fed, the central rotation axes 213 are provided at the top and bottom of the open slit 211, respectively, for rotatable connection of the disc-shaped rotary cutting members 220, and the grip portion 215 is provided at the rear thereof for gripping by a user.

The cutter body 210 comprises first and second cutter body members 210a and 210b of the same shape, which face each other and are connected with each other. In the first and second cutter body members 210a and 210b, an open portion 211a which narrows inwardly is formed in the front thereof to be biased downward past the center line, the central rotation axis 213 is formed to protrude from the inner surface thereof below the open portion 211a for rotatable connection of each of the disc-shaped rotary cutting members 220, a coupling groove 213a into which an end the central rotation axis 213 is inserted is formed above the open portion 211a, and a receiving groove 213b for the disc-shaped rotary cutting member 220 is formed around the central rotation axis 213 and the coupling groove 213a. The open slit 211 of the cutter body 210 is formed by intersection of the open portions 211a as the straight extension portions 111a are spaced from each other and extend in parallel to each other when the first and second cutter body members 210a and 210b are connected with each other.

The disc-shaped rotary cutting members 220 are inserted into the central rotation axes 213 provided in the cutter body 210, respectively, and rotatably connected thereto. When a user grips the grip portion 215 of the cutter body 210, inserts an object 3 to be cut into the open slit 211, and then pushes the cutter body 210 forward, the object 3 is fed between the cutting blades 223 of the disc-shaped rotary cutting members 220, which protrude through the open slit 211 and overlap each other, and the cutting blades 223 are automatically rotated by friction to cut the object 3.

A central hole 221 is formed in the center of each of the disc-shaped rotary cutting members 220 such that the disc-shaped rotary cutting member 220 can be rotatably connected to the central rotation axis 213 of the cutter body 210.

The cutting blades 223 are formed on the edges of the disc-shaped rotary cutting members 220 to protrude through the open slit 211 and overlap each other, and thus when the object 3 to be cut is fed therebetween, the cutting blades 223 are automatically rotated by friction to cut the object 3.

Stepped portions for separation and discharge 230 are formed on both sides of the above-described cutter body 210 to guide the object 3, which is fed into the open slit 211 and cut into both sides by the disc-shaped rotary cutting members 220, such that both sides are separated from each other and discharged to the outside. The stepped portions 230 are stepped from the rear end of the open slit 211 to both sides of the cutter body 210.

As shown in the figures, the stepped portions 230 may extend obliquely upward from the rear end of the open slit 211 at one side of the cutter body 210 and extend obliquely downward from the rear end of the open slit 211 at the other side of the cutter body 210. Moreover, although not shown in the figures, the stepped portions 230 may extend to be bent obliquely upward from the rear end of the open slit 211 at one side of the cutter body 210 and extend to be bent obliquely downward from the rear end of the open slit 211 at the other side of the cutter body 210.

Furthermore, although not shown in the figures, it is preferred that an inclined surface is formed at the side of the stepped portion 230, and the inclined surface reduces the thickness of the cutter body 210 in the area of the stepped portion 230 and thus serves to guide the object 3, which is fed into the open slit 211 and cut into both sides by the disc-shaped rotary cutting members 220, such that both sides are not caught by the stepped portions 230 so as to prevent the occurrence of cutting failure and, at the same time, guide both sides of the cut object 3 to be naturally separated and discharged through the stepped portions 230.

In addition, the grip portion 215 of the cutter body 210 may form a handle for gripping by a user and may be inserted into an additional handle member 240. The additional handle member 240 is to extend the length of the grip portion 215 and includes an insertion groove 241 formed in the front thereof, into which the grip portion 215 is inserted and connected.

In this case, in order for the grip portion 215 of the cutter body 210 not to be easily separated from the insertion groove 241 of the additional handle member 240, it is preferred that a leaf spring 217, which is in close contact with the insertion groove 241 of the additional handle member 240, is provided in the grip portion 215 of the cutter body 210, as shown in FIG. 6.

With the use of the above-described anti-jam safety cutter 200 in accordance with the second embodiment of the present disclosure, when a user grips the grip portion 215 of the cutter body 210, inserts an object 3 to be cut into the open slit 211, and then pushes the cutter body 210 forward, the disc-shaped rotary cutting members 220 are rotated across the center of the object 3 by friction due to the object 3 so as to rapidly, easily, and safely cut the object 3 without having to perform scissoring, as shown in FIG. 6.

Particularly, in the case of the anti-jam safety cutter 200 in accordance with the second embodiment of the present disclosure, the disc-shaped rotary cutting members 220 are inserted into the central rotation axes 213 provided in the cutter body 210 and rotatably connected thereto without any fastening members, and thus it is possible to prevent the object 3 cut by the disc-shaped rotary cutting members 220 from being jammed in a gap between the disc-shaped rotary cutting members 220 and the head portions of the fastening members, even when the cutting direction of the disc-shaped rotary cutting members 220 is changed in a diagonal or curved line. As a result, the change of direction to the diagonal and curved lines as well as the straight line can be made quite freely.

Moreover, in the case of the anti-jam safety cutter 200 in accordance with the second embodiment of the present disclosure, the cutting blades 223 of the disc-shaped rotary cutting members 220 are exposed within the open slit 211 only, and thus it is possible to prevent the occurrence of safety accidents such as injury caused by the cutting blades 223. Furthermore, the stepped portions 230 are stepped from the rear end of the open slit 211 to both sides of the cutter body 210, and thus it is possible to easily separate and discharge both sides of the object 3 cut by the disc-shaped rotary cutting members 220, which enables the cutting operation to be rapidly and easily performed.

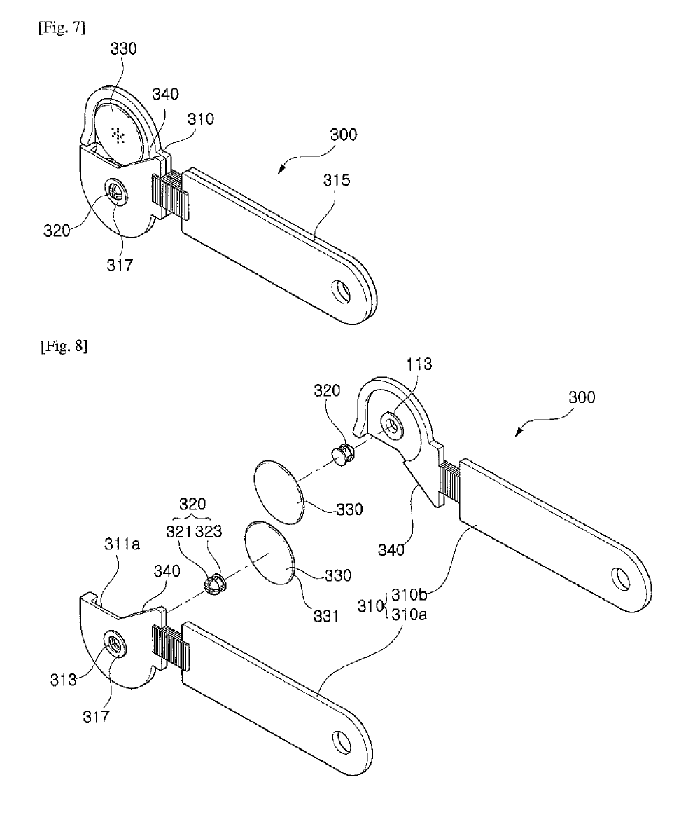

An anti-jam safety cutter 300 in accordance with a third embodiment of the present disclosure is configured such that disc-shaped rotary cutting members 330 are rotated across the center of an object 3 to be cut by a simple pushing force without having to perform scissoring so as to rapidly, easily, and safely cut the object 3 and is further configured such that the object 3 to be cut is prevented from being jammed when the cutting direction of the disc-shaped rotary cutting members 330 is changed in a diagonal or curved line. As shown in FIGS. 7 to 9, the anti-jam safety cutter 300 in accordance with the third embodiment of the present disclosure comprises: a cutter body 310 which includes an open slit 311 formed in the front thereof, coupling holes 313 formed at the top and bottom of the open slit 311, respectively, and a grip portion 315 provided at the rear thereof; rotary couplers 320 which are rotatably connected to the coupling holes 313 of the cutter body 310, respectively; and disc-shaped rotary cutting members 330 of which each center is integrally coupled to one side of each of the rotary couplers 320 and which include cutting blades 331 formed on the edges of the disc-shaped rotary cutting members 330 to protrude through the open slit 311 and overlap each other.

Here, the cutter body 310 is to form a frame for installation of the disc-shaped rotary cutting members 330, in which the open slit 311 is formed in the front thereof, through which the object 3 to be cut such as paper, film, fabric, etc. is fed, the coupling holes 313 are formed at the top and bottom of the open slit 311, respectively, for rotatable connection of the disc-shaped rotary cutting members 330, and the grip portion 315 is provided at the rear thereof for gripping by a user.

The cutter body 310 comprises first and second cutter body members 310a and 310b of the same shape, which face each other and are connected with each other. In the first and second cutter body members 310a and 310b, the coupling hole 313 is formed in the center of one side thereof when viewed from the outside, straight extension portions 311a are formed at the top of the coupling holes 313 to form the open slit 311 when the first and second cutter body members 310a and 310b are connected with each other, stepped portions for separation and discharge 340, which will be described later, are formed at the end of the straight extension portions 311a, respectively, and the portion extending from the other side forms the grip portion 315 when the first and second cutter body members 310a and 310b are connected with each other. The open slit 311 of the cutter body 310 is formed as the straight extension portions 111a are spaced from each other and extend in parallel to each other when the first and second cutter body members 310a and 310b are connected with each other.

The rotary couplers 320 are rotatably connected to the coupling holes 313 of the above-described cutter body 310. These rotary couplers 320 are the parts that connect the cutter body 310 and the disc-shaped rotary cutting members 330 such that the disc-shaped rotary cutting members 330 can be rotatably connected to the coupling holes 313 of the cutter body 310. Each of the rotary couplers 320 comprises a coupling protrusion 321 formed to protrude from one side thereof and rotatably connected to the coupling hole 313 of the cutter body 310 and a coupling plate 323 formed on the other side thereof and integrally coupled to the center of each of the disc-shaped rotary cutting members 330.

It is preferred that the coupling protrusions 321 of the rotary couplers 320 have a “cross (+)” shape so as to be easily coupled to the coupling holes 313 of the cutter body 310 and exert their elasticity during assembly.

Moreover, in order for the rotary couplers 320 not to be arbitrarily separated by an external force after assembly, it is preferred that a ring-shaped protection protrusion 317 is formed on the outer surface of the cutter body 310 to protrude from the circumference of each of the coupling holes 313 so as to surround the end of the coupling protrusion 321 protruding externally.

The center of the disc-shaped rotary cutting members 330 is integrally coupled to one side of the above-described rotary couplers 320, respectively. When a user grips the grip portion 315 of the cutter body 310, inserts an object 3 to be cut into the open slit 311, and then pushes the cutter body 310 forward, the object 3 is fed between the cutting blades 331 of the disc-shaped rotary cutting members 330, which protrude through the open slit 311 and overlap each other, and the cutting blades 331 are automatically rotated by friction to cut the object 3.

It is preferred that the rotary couplers 320 and the disc-shaped rotary cutting members 330 are made of metal materials and the center of each of the disc-shaped rotary cutting members 330 is integrally coupled to one side of each of the rotary couplers 320, i.e., to the coupling plate 323 by welding.

The cutting blades 331 are formed on the edges of the disc-shaped rotary cutting members 330 to protrude through the open slit 311 and overlap each other, and thus when the object 3 to be cut is fed therebetween, the cutting blades 331 are automatically rotated by friction to cut the object 3.

Stepped portions for separation and discharge 340 are formed on both sides of the above-described cutter body 310 to guide the object 3, which is fed into the open slit 311 and cut into both sides by the disc-shaped rotary cutting members 330, such that both sides are separated from each other and discharged to the outside. The stepped portions 340 are stepped from the rear end of the open slit 311 to both sides of the cutter body 310.

As shown in the figures, the stepped portions 340 may extend obliquely upward from the rear end of the open slit 311 at one side of the cutter body 310 and extend obliquely downward from the rear end of the open slit 311 at the other side of the cutter body 310. Moreover, although not shown in the figures, the stepped portions 340 may extend to be bent obliquely upward from the rear end of the open slit 311 at one side of the cutter body 310 and extend to be bent obliquely downward from the rear end of the open slit 311 at the other side of the cutter body 310.

Furthermore, although not shown in the figures, it is preferred that an inclined surface is formed at the side of the stepped portion 340, and the inclined surface reduces the thickness of the cutter body 310 in the area of the stepped portion 340 and thus serves to guide the object 3, which is fed into the open slit 311 and cut into both sides by the disc-shaped rotary cutting members 330, such that both sides are not caught by the stepped portions 340 so as to prevent the occurrence of cutting failure and, at the same time, guide both sides of the cut object 3 to be naturally separated and discharged through the stepped portions 340.

With the use of the above-described anti-jam safety cutter 300 in accordance with the third embodiment of the present disclosure, when a user grips the grip portion 315 of the cutter body 310, inserts an object 3 to be cut into the open slit 311, and then pushes the cutter body 310 forward, the disc-shaped rotary cutting members 330 are rotated across the center of the object 3 by friction due to the object 3 so as to rapidly, easily, and safely cut the object 3 without having to perform scissoring, as shown in FIG. 9.

Particularly, in the case of the anti-jam safety cutter 300 in accordance with the third embodiment of the present disclosure, the center of each of the disc-shaped rotary cutting members 330 is integrally coupled by welding, for example, to the rotary couplers 320 rotatably connected to the coupling holes 313 and is rotated together without any fastening members, and thus it is possible to prevent the object 3 cut by the disc-shaped rotary cutting members 330 from being jammed in a gap between the disc-shaped rotary cutting members 330 and the fastening members, even when the cutting direction of the disc-shaped rotary cutting members 330 is changed in a diagonal or curved line. As a result, the change of direction to the diagonal and curved lines as well as the straight line can be made quite freely.

Moreover, in the case of the anti-jam safety cutter 300 in accordance with the third embodiment of the present disclosure, the cutting blades 331 of the disc-shaped rotary cutting members 330 are exposed within the open slit 311 only, and thus it is possible to prevent the occurrence of safety accidents such as injury caused by the cutting blades 331. Furthermore, the stepped portions 340 are stepped from the rear end of the open slit 311 to both sides of the cutter body 310, and thus it is possible to easily separate and discharge both sides of the object 3 cut by the disc-shaped rotary cutting members 330, which enables the cutting operation to be rapidly and easily performed.

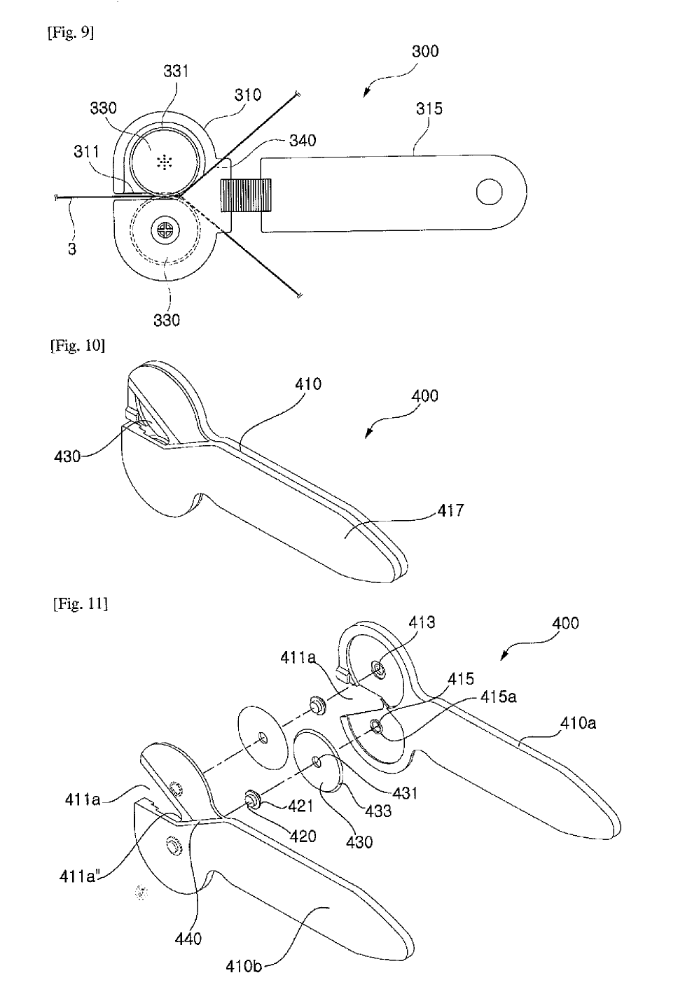

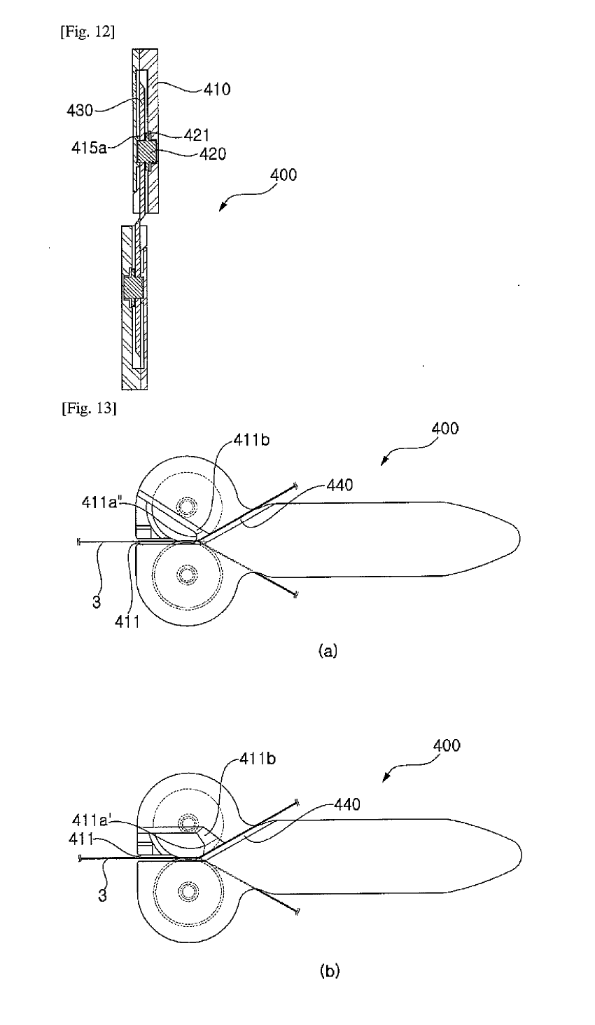

An anti-jam safety cutter 400 in accordance with a fourth embodiment of the present disclosure is configured such that disc-shaped rotary cutting members 430 are rotated across the center of an object 3 to be cut by a simple pushing force without having to perform scissoring so as to rapidly, easily, and safely cut the object 3 and is further configured such that the object 3 to be cut is prevented from being jammed when the cutting direction of the disc-shaped rotary cutting members 430 is changed in a diagonal or curved line. As shown in FIGS. 10 to 13, the anti-jam safety cutter 400 in accordance with the fourth embodiment of the present disclosure comprises: a cutter body 410 which includes an open slit 411 formed in the front thereof, first and second receiving grooves 413 and 415 formed to correspond to each other on the inner wall at the top and bottom of the open slit 411, respectively, and a grip portion 417 provided at the rear thereof; rotation axes 420 of which both ends are rotatably connected to the first and second receiving grooves 413 and 415 of the cutter body 410, respectively, and each formed integrally with a support disc 421; and disc-shaped rotary cutting members 430 which are inserted into the rotation axes 420 to be in surface contact with the support discs 421 and which include cutting blades 433 formed on the edges thereof to protrude through the open slit 411 and overlap each other.

Here, the cutter body 410 is to form a frame for installation of the disc-shaped rotary cutting members 430, in which the open slit 411 is formed in the front thereof, through which the object 3 to be cut such as paper, film, fabric, etc. is fed, the first and second receiving grooves 413 and 415 are formed to correspond to each other on the inner wall at the top and bottom of the open slit 411, respectively, to simultaneously support the rotation axes 420 and the disc-shaped rotary cutting members 430 for rotation of the disc-shaped rotary cutting members 430, and the grip portion 417 is provided at the rear thereof for gripping by a user.

The cutter body 410 comprises first and second cutter body members 410a and 410b of the same shape, which face each other and are connected with each other. In the first and second cutter body members 410a and 410b, an open portion 411a which narrows inwardly is formed in the front thereof to be biased downward past the center line, the first receiving groove 413 is formed on the inner surface thereof above the open portion 411a, and the second receiving groove 415 is formed below the open portion 411a. The open slit 411 of the cutter body 410 is formed by intersection of the open portions 411a when the first and second cutter body members 410a and 410b are connected with each other.

Moreover, it is preferred that the open portions 411a of the first and second cutter body members 410a and 410b include a plurality of obtusely-bent portions 411a′ or round portions 411a″ as shown in FIG. 13 such that the object 3 to be cut, which is brought into close contact with the open portions 411a when the cutting direction is changed, is not caught but naturally bent. Furthermore, it is preferred that a multi-stepped portion 411b, which is lowered from the plurality of obtusely-bent portions 411a′ or round portions 411a″, is formed on the outer surface of the open portions 411a of the first and second cutter body members 410a and 410b, respectively, such that the object 3, which is brought into close contact with the open portions 411a when the cutting direction is changed, is naturally bent.

Both ends of each of the rotation axes 420 are rotatably connected to the first and second receiving grooves 413 and 415 of the above-described cutter body 410. These rotation axes 420 are rotated together with the disc-shaped rotary cutting members 430 so as to solve the problem of reduction of cutting forces caused when the gap between the disc-shaped rotary cutting members 430 in surface contact with each other is increased by vibration during rotation of the disc-shaped rotary cutting members 430 or when specific portions of fixed axes, into which the disc-shaped rotary cutting members 430 are rotatably inserted, are worn out by the disc-shaped rotary cutting members 430. The support disc 421, which is in surface contact with one side of each of the disc-shaped rotary cutting members 430, is integrally formed in the center of the rotation axes 420.

It is preferred that the first receiving groove 413 of the cutter body 410 is formed as a two-stepped groove, with which one end of the rotation axis 420 is in surface contact and in which the support disc 421 is received, and a circular protrusion 415a, which is in surface contact with the other side of the rotation axis 420, is provided on the circumference of the second receiving groove 415 of the cutter body 410 such that the other end of the rotation axis 420 is kept spaced within the second receiving groove 415. Moreover, the circular protrusion 415a has an outer diameter smaller than that of the support disc 421 such that rotation axes 420 and the disc-shaped rotary cutting members 430 can be rotated by the difference in friction force caused due to the surface contact area between the support disc 421 of the rotation axis 420 and the disc-shaped rotary cutting member 430, which is greater than the surface contact area between the circular protrusion 415a of the second receiving groove 415 and the disc-shaped rotary cutting member 430.

The disc-shaped rotary cutting member 430 is inserted into the above-described rotation axis 420 and is in surface contact with the support disc 421. When a user grips the grip portion 417 of the cutter body 410, inserts an object 3 to be cut into the open slit 411, and then pushes the cutter body 410 forward, the object 3 is fed between the cutting blades 433 of the disc-shaped rotary cutting members 430, which protrude through the open slit 411 and overlap each other, and the cutting blades 433 are automatically rotated by friction to cut the object 3. Central holes 431, into which the rotation axes 420 are inserted, are formed in the center of the disc-shaped rotary cutting members 430 and cutting blades 433 are formed on the edges thereof to protrude through the open slit 411 and overlap each other.

Stepped portions for separation and discharge 440 are formed on both sides of the above-described cutter body 410 to guide the object 3, which is fed into the open slit 411 and cut into both sides by the disc-shaped rotary cutting members 430, such that both sides are separated from each other and discharged to the outside. The stepped portions 440 are stepped from the rear end of the open slit 411 to both sides of the cutter body 410.

As shown in the figures, the stepped portions 440 may extend obliquely upward from the rear end of the open slit 411 at one side of the cutter body 410 and extend obliquely downward from the rear end of the open slit 411 at the other side of the cutter body 410. Moreover, although not shown in the figures, the stepped portions 440 may extend to be bent obliquely upward from the rear end of the open slit 411 at one side of the cutter body 410 and extend to be bent obliquely downward from the rear end of the open slit 411 at the other side of the cutter body 410.

Furthermore, although not shown in the figures, it is preferred that an inclined surface 441 is formed at the side of the stepped portion 440, and the inclined surface reduces the thickness of the cutter body 410 in the area of the stepped portion 440 and thus serves to guide the object 3, which is fed into the open slit 411 and cut into both sides by the disc-shaped rotary cutting members 430, such that both sides are not caught by the stepped portions 440 so as to prevent the occurrence of cutting failure and, at the same time, guide both sides of the cut object 3 to be naturally separated and discharged through the stepped portions 440.

With the use of the above-described anti-jam safety cutter 400 in accordance with the fourth embodiment of the present disclosure, when a user grips the grip portion 417 of the cutter body 410, inserts an object 3 to be cut into the open slit 411, and then pushes the cutter body 410 forward, the disc-shaped rotary cutting members 430 are rotated across the center of the object 3 by friction due to the object 3 so as to rapidly, easily, and safely cut the object 3 without having to perform scissoring, as shown in FIG. 13.

Particularly, in the case of the anti-jam safety cutter 400 in accordance with the fourth embodiment of the present disclosure, the disc-shaped rotary cutting members 430 are rotatably connected to the inside of the cutter body 410 only by the rotation axes 420 provided inside the cutter body 410 without any fastening members exposed to the outside of the cutting body 410, and thus it is possible to prevent the object 3 cut by the disc-shaped rotary cutting members 430 from being jammed in a gap between the disc-shaped rotary cutting members 430 and the fastening members, even when the cutting direction of the disc-shaped rotary cutting members 430 is changed in a diagonal or curved line. As a result, the change of direction to the diagonal and curved lines as well as the straight line can be made quite freely.

Moreover, in the case of the anti-jam safety cutter 400 in accordance with the fourth embodiment of the present disclosure, the cutting blades 433 of the disc-shaped rotary cutting members 430 are exposed within the open slit 411 only, and thus it is possible to prevent the occurrence of safety accidents such as injury caused by the cutting blades 433. Furthermore, the stepped portions 440 are stepped from the rear end of the open slit 411 to both sides of the cutter body 410, and thus it is possible to easily separate and discharge both sides of the object 3 cut by the disc-shaped rotary cutting members 430, which enables the cutting operation to be rapidly and easily performed.

Furthermore, in the case of the anti-jam safety cutter 400 in accordance with the fourth embodiment of the present disclosure, the open portions 411a of the first and second cutter body members 410a and 410b include the plurality of obtusely-bent portions 411a′ or round portions 411a″, the multi-stepped portion 411b, which is lowered from the plurality of obtusely-bent portions 411a′ or round portions 411a″, is formed on the outer surface of the open portions 411a of the first and second cutter body members 410a and 410b, respectively, and thus the object 3, which is brought into close contact with the open portions 411a when the cutting direction of the disc-shaped rotary cutting members 430 is changed in a diagonal or curved line, is not caught but naturally bent and discharged.

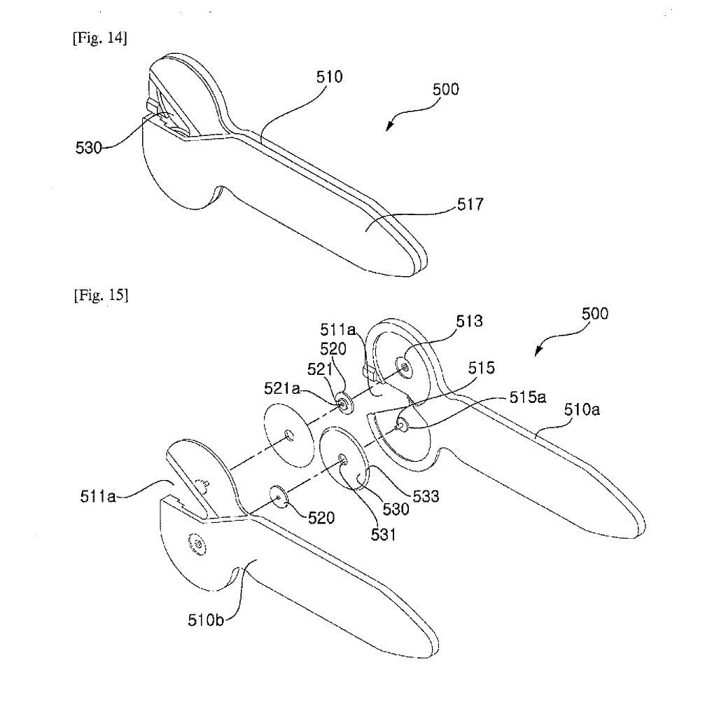

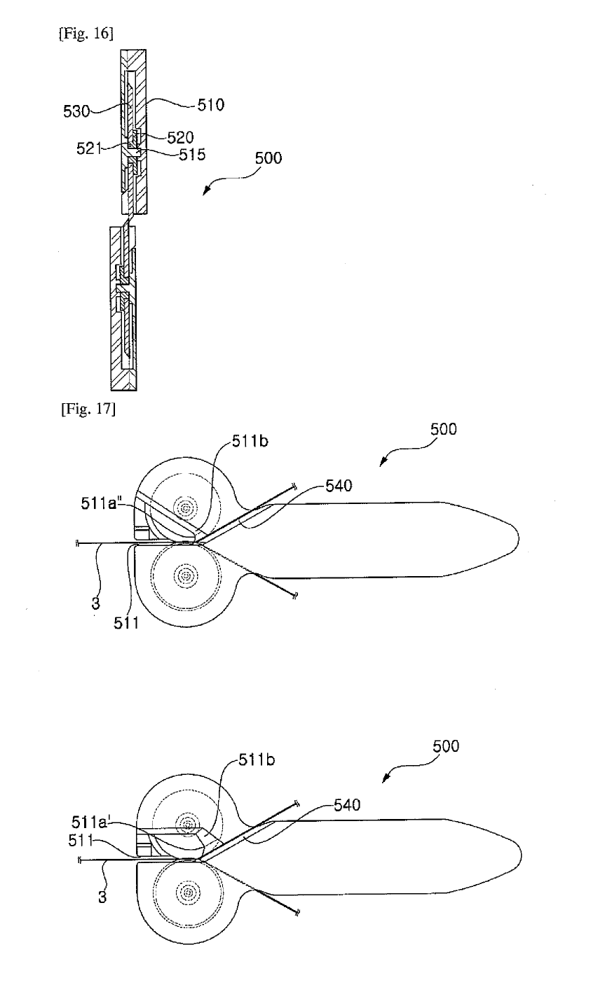

An anti-jam safety cutter 500 in accordance with a fifth embodiment of the present disclosure is configured such that disc-shaped rotary cutting members 530 are rotated across the center of an object 3 to be cut by a simple pushing force without having to perform scissoring so as to rapidly, easily, and safely cut the object 3 and is further configured such that the object 3 to be cut is prevented from being jammed when the cutting direction of the disc-shaped rotary cutting members 530 is changed in a diagonal or curved line. As shown in FIGS. 14 to 17, the anti-jam safety cutter 500 in accordance with the fifth embodiment of the present disclosure comprises: a cutter body 510 which includes an open slit 511 formed in the front thereof, receiving grooves 513 and central axes 515 formed to correspond to each other on the inner wall at the top and bottom of the open slit 511, respectively, and a grip portion 517 provided at the rear thereof; rotary discs 520 which are received in the receiving grooves 513 of the cutter body 510 and each includes a coupling protrusion 521 having a central axis through hole 521a; and disc-shaped rotary cutting members 530 which are inserted into the coupling protrusions 521 of the rotary discs 520 such that one side of each of the disc-shaped rotary cutting members 530 is in surface contact with the rotary disc 520 and which include cutting blades 533 formed on the edges thereof to protrude through the open slit 511 and overlap each other.

Here, the cutter body 510 is to form a frame for installation of the disc-shaped rotary cutting members 530, in which the open slit 511 is formed in the front thereof, through which the object 3 to be cut such as paper, film, fabric, etc. is fed, the receiving grooves 513 for reception of the rotary discs 520 and the central axes 515 penetrating the rotary discs 520 are formed to correspond to each other on the inner wall at the top and bottom of the open slit 511, respectively, and the grip portion 517 is formed at the rear thereof for gripping by a user.

The cutter body 510 comprises first and second cutter body members 510a and 510b of the same shape, which face each other and are connected with each other. In the first and second cutter body members 510a and 510b, an open portion 511a which narrows inwardly is formed in the front thereof to be biased downward past the center line, the receiving groove 513 is formed on the inner surface thereof above the open portion 511a, and the central axis 515 is formed below the open portion 511a. The open slit 511 of the cutter body 510 is formed by intersection of the open portions 511a when the first and second cutter body members 510a and 510b are connected with each other.

Moreover, it is preferred that the open portions 511a of the first and second cutter body members 510a and 510b include a plurality of obtusely-bent portions 511a′ or round portions 511a″ as shown in FIG. 17 such that the object 3 to be cut, which is brought into close contact with the open portions 511a when the cutting direction is changed, is not caught but naturally bent. Furthermore, it is preferred that a multi-stepped portion 511b, which is lowered from the plurality of obtusely-bent portions 511a′ or round portions 511a″, is formed on the outer surface of the open portions 511a of the first and second cutter body members 510a and 510b, respectively, such that the object 3, which is brought into close contact with the open portions 511a when the cutting direction is changed, is naturally bent.

The rotary discs 520 are received in the receiving grooves 513 of the above-described cutter body 510. These rotary discs 520 are in surface contact with the disc-shaped rotary cutting members 530 and rotated together with the disc-shaped rotary cutting members 530 so as to solve the problem of reduction of cutting forces caused when the gap between the disc-shaped rotary cutting members 530 in surface contact with each other is increased by vibration during rotation of the disc-shaped rotary cutting members 530 or when specific portions of fixed axes, into which the disc-shaped rotary cutting members 530 are rotatably inserted, are worn out by the disc-shaped rotary cutting members 530. The coupling protrusion 52 inserted into the disc-shaped rotary cutting member 530 is formed in the center of the rotary discs 520, and the central axis through hole 521a is formed in the center of the coupling protrusion 521.

A central axis coupling hole 513a, to which the corresponding central axis 515 is connected, is formed in the receiving groove 513 of the cutter body 510, and a disc-shaped support protrusion 515a, which is in surface contact with the other side of the disc-shaped rotary cutting member 530, is integrally provided at the bottom of the central axis 515. Here, it is preferred that the disc-shaped support protrusion 515a has an outer diameter smaller than that of the rotary disc 520 such that rotation axes 520 and the disc-shaped rotary cutting members 530 can be rotated by the difference in friction force caused due to the surface contact area between the rotary disc 520 and the disc-shaped rotary cutting member 530, which is greater than the surface contact area between the disc-shaped support protrusion 515a of the central axis 515 and the disc-shaped rotary cutting member 530.

The disc-shaped rotary cutting member 530 is inserted into the above-described coupling protrusion 521 and is in surface contact with the rotary disc 520. When a user grips the grip portion 517 of the cutter body 510, inserts an object 3 to be cut into the open slit 511, and then pushes the cutter body 510 forward, the object 3 is fed between the cutting blades 533 of the disc-shaped rotary cutting members 530, which protrude through the open slit 511 and overlap each other, and the cutting blades 533 are automatically rotated by friction to cut the object 3. Central holes 531, into which the coupling protrusions 521 of the rotary discs 520 are inserted, are formed in the center of the disc-shaped rotary cutting members 530 and cutting blades 533 are formed on the edges thereof to protrude through the open slit 511 and overlap each other.

Stepped portions for separation and discharge 540 are formed on both sides of the above-described cutter body 510 to guide the object 3, which is fed into the open slit 511 and cut into both sides by the disc-shaped rotary cutting members 530, such that both sides are separated from each other and discharged to the outside. The stepped portions 540 are stepped from the rear end of the open slit 511 to both sides of the cutter body 510.

As shown in the figures, the stepped portions 540 may extend obliquely upward from the rear end of the open slit 511 at one side of the cutter body 510 and extend obliquely downward from the rear end of the open slit 511 at the other side of the cutter body 510. Moreover, although not shown in the figures, the stepped portions 540 may extend to be bent obliquely upward from the rear end of the open slit 511 at one side of the cutter body 510 and extend to be bent obliquely downward from the rear end of the open slit 511 at the other side of the cutter body 510.

Furthermore, although not shown in the figures, it is preferred that an inclined surface 541 is formed at the side of the stepped portion 540, and the inclined surface 541 surface reduces the thickness of the cutter body 510 in the area of the stepped portion 540 and thus serves to guide the object 3, which is fed into the open slit 511 and cut into both sides by the disc-shaped rotary cutting members 530, such that both sides are not caught by the stepped portions 540 so as to prevent the occurrence of cutting failure and, at the same time, guide both sides of the cut object 3 to be naturally separated and discharged through the stepped portions 540.

With the use of the above-described anti-jam safety cutter 500 in accordance with the fifth embodiment of the present disclosure, when a user grips the grip portion 517 of the cutter body 510, inserts an object 3 to be cut into the open slit 511, and then pushes the cutter body 510 forward, the disc-shaped rotary cutting members 530 are rotated across the center of the object 3 by friction due to the object 3 so as to rapidly, easily, and safely cut the object 3 without having to perform scissoring, as shown in FIG. 17.

Particularly, in the case of the anti-jam safety cutter 500 in accordance with the fifth embodiment of the present disclosure, the disc-shaped rotary cutting members 530 are rotatably connected to the inside of the cutter body 510 only by the rotary discs 520 provided inside the cutter body 510 without any fastening members exposed to the outside of the cutting body 510, and thus it is possible to prevent the object 3 cut by the disc-shaped rotary cutting members 530 from being jammed in a gap between the disc-shaped rotary cutting members 530 and the fastening members, even when the cutting direction of the disc-shaped rotary cutting members 530 is changed in a diagonal or curved line. As a result, the change of direction to the diagonal and curved lines as well as the straight line can be made quite freely.

Moreover, in the case of the anti-jam safety cutter 500 in accordance with the fifth embodiment of the present disclosure, the cutting blades 533 of the disc-shaped rotary cutting members 530 are exposed within the open slit 511 only, and thus it is possible to prevent the occurrence of safety accidents such as injury caused by the cutting blades 533. Furthermore, the stepped portions 540 are stepped from the rear end of the open slit 511 to both sides of the cutter body 510, and thus it is possible to easily separate and discharge both sides of the object 3 cut by the disc-shaped rotary cutting members 530, which enables the cutting operation to be rapidly and easily performed.

Furthermore, in the case of the anti-jam safety cutter 500 in accordance with the fifth embodiment of the present disclosure, the open portions 511a of the first and second cutter body members 510a and 510b include the plurality of obtusely-bent portions 511a′ or round portions 511a″, the multi-stepped portion 511b, which is lowered from the plurality of obtusely-bent portions 511a′ or round portions 511a″, is formed on the outer surface of the open portions 511a of the first and second cutter body members 510a and 510b, respectively, and thus the object 3, which is brought into close contact with the open portions 511a when the cutting direction of the disc-shaped rotary cutting members 530 is changed in a diagonal or curved line, is not caught but naturally bent and discharged.

As described above, the anti-jam safety cutter according to the present disclosure can be used as a substitute for scissors or knives that are used to cut an object such as paper, film, fabric, etc.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An anti-jam safety cutter comprising:
a cutter body which includes an open slit formed in the front thereof, coupling holes formed at the top and bottom of the open slit, respectively, and a grip portion provided at the rear thereof;
disc-shaped rotary cutting members which are rotatably connected to the top and bottom of the front of the cutter body, respectively, and which include central holes formed in the center thereof to communicate with the coupling holes of the cutter body, insertion holes spaced in the radial direction from the central holes, and cutting blades formed on the edges thereof to protrude through the open slit and overlap each other; and
fastening members which rotatably connect the disc-shaped rotary cutting members to the top and bottom of the front of the cutter body, respectively, and which include central coupling protrusions provided in the center thereof to be sequentially inserted and coupled to the central holes of the disc-shaped rotary cutting members and the coupling holes of the cutter body, and anti-jam insertion protrusions provided at the outside in the radial direction to be inserted and fixed to the insertion holes of the disc-shaped rotary cutting members to prevent an object to be cut from being jammed when the cutting direction is changed.

2. The anti-jam safety cutter of claim 1, further comprising stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

3. The anti-jam safety cutter of claim 1, wherein the central coupling protrusions of the fastening members have a “cross (+)” shape so as to exert their elasticity.

4. The anti-jam safety cutter of claim 1, wherein the insertion holes of the disc-shaped rotary cutting members is provided at angular intervals of 90 degrees, and the anti-jam insertion protrusions of the fastening members are provided at angular intervals of 90 degrees to match the insertion holes.

5. An anti-jam safety cutter, comprising:
a cutter body which includes an open slit formed in the front thereof, central rotation axes provided at the top and bottom of the open slit, respectively, and a grip portion provided at the rear thereof; and
disc-shaped rotary cutting members which are inserted into the central rotation axes provided in the cutter body, respectively, and rotatably connected thereto and which include cutting blades formed on the edges thereof to protrude through the open slit and overlap each other.

6. The anti-jam safety cutter of claim 5, further comprising stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

7. The anti-jam safety cutter of claim 5, further comprising an additional handle member including an insertion groove formed in the front thereof, into which the grip portion is inserted and connected.

8. The anti-jam safety cutter of claim 7, wherein a leaf spring for adjusting the length of the additional handle member inserted into the insertion groove is provided at one side of the grip portion of the cutter body.

9. The anti-jam safety cutter of claim 5, wherein the cutter body comprises first and second cutter body members of the same shape, which face each other and are connected with each other, wherein an open portion which narrows inwardly is formed in the front thereof to be biased downward past the center line, the central rotation axis is formed to protrude from the inner surface thereof below the open portion, a coupling groove into which an end of the central rotation axis is inserted is formed above the open portion, and a receiving groove for the disc-shaped rotary cutting member is formed around the central rotation axis and the coupling groove, and wherein the open slit of the cutter body is formed by intersection of the open portions when the first and second cutter body members are connected with each other.

10. An anti-jam safety cutter comprising:
a cutter body which includes an open slit formed in the front thereof, coupling holes formed at the top and bottom of the open slit, respectively, and a grip portion provided at the rear thereof;
rotary couplers which are rotatably connected to the coupling holes of the cutter body, respectively; and
disc-shaped rotary cutting members of which each center is integrally coupled to one side of each of the rotary couplers and which include cutting blades formed on the edges of the disc-shaped rotary cutting members to protrude through the open slit and overlap each other.

11. The anti-jam safety cutter of claim 10, further comprising stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

12. The anti-jam safety cutter of claim 10, wherein the rotary couplers and the disc-shaped rotary cutting members are made of metal materials and the center of each of the disc-shaped rotary cutting members is integrally coupled to one side of each of the rotary couplers by welding.

13. An anti-jam safety cutter, comprising:
a cutter body which includes an open slit formed in the front thereof, first and second receiving grooves formed to correspond to each other on the inner wall at the top and bottom of the open slit, respectively, and a grip portion provided at the rear thereof;
rotation axes of which both ends are rotatably connected to the first and second receiving grooves of the cutter body, respectively, and each formed integrally with a support disc; and
disc-shaped rotary cutting members which are inserted into the rotation axes to be in surface contact with the support discs and which include cutting blades formed on the edges thereof to protrude through the open slit and overlap each other,
wherein, the first receiving groove of the cutter body is formed as a two-stepped groove, with which one end of the rotation axis is in surface contact and in which the support disc is received, wherein a circular protrusion, which is in surface contact with the other side of the rotation axis, is provided on the circumference of the second receiving groove of the cutter body such that the other end of the rotation axis is kept spaced within the second receiving groove, and wherein the circular protrusion has an outer diameter smaller than that of the support disc.

14. The anti-jam safety cutter of claim 13, further comprising stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

15. The anti-jam safety cutter of claim 13, wherein the cutter body comprises first and second cutter body members of the same shape, which face each other and are connected with each other, wherein an open portion which narrows inwardly is formed in the front thereof to be biased downward past the center line, the first receiving groove is formed on the inner surface thereof above the open portion, and the second receiving groove is formed below the open portion, and wherein the open slit of the cutter body is formed by intersection of the open portions when the first and second cutter body members are connected with each other.

16. The anti-jam safety cutter of claim 15, wherein the open portions of the first and second cutter body members comprise a plurality of obtusely-bent portions or round portions such that an object to be cut, which is brought into close contact with the open portions when the cutting direction is changed, can be naturally bent.

17. The anti-jam safety cutter of claim 15, wherein a multi-stepped portion, which is lowered from the plurality of obtusely-bent portions or round portions, is formed on the outer surface of the open portions of the first and second cutter body members, respectively, such that the object, which is brought into close contact with the open portions when the cutting direction is changed, can be naturally bent.

18. An anti-jam safety cutter, comprising:
a cutter body which includes an open slit formed in the front thereof, receiving grooves and central axes formed to correspond to each other on the inner wall at the top and bottom of the open slit, respectively, and a grip portion provided at the rear thereof;
rotary discs which are received in the receiving grooves of the cutter body and each includes a coupling protrusion having a central axis through hole; and
disc-shaped rotary cutting members which are inserted into the coupling protrusions of the rotary discs such that one side of each of the disc-shaped rotary cutting members is in surface contact with the rotary disc and which include cutting blades formed on the edges thereof to protrude through the open slit and overlap each other,
wherein, a central axis coupling hole, to which the central axis is connected, is formed in the receiving groove of the cutter body, and wherein a disc-shaped support protrusion, which is in surface contact with the other side of the disc-shaped rotary cutting member and has an outer diameter smaller than that of the rotary disc, is integrally provided at the bottom of the central axis.

19. The anti-jam safety cutter of claim 18, further comprising stepped portions for separation and discharge which are formed on both sides of the cutter body and stepped from the rear end of the open slit to both sides of the cutter body to guide both sides of the object cut by the disc-shaped rotary cutting members to be separated from each other and discharged to the outside.

20. The anti-jam safety cutter of claim 18, wherein the cutter body comprises first and second cutter body members of the same shape, which face each other and are connected with each other, wherein an open portion which narrows inwardly is formed in the front thereof to be biased downward past the center line, the receiving groove is formed on the inner surface thereof above the open portion, and the central axis is formed below the open portion, and wherein the open slit of the cutter body is formed by intersection of the open portions when the first and second cutter body members are connected with each other.

21. The anti-jam safety cutter of claim 20, wherein the open portions of the first and second cutter body members comprise a plurality of obtusely-bent portions or round portions such that an object to be cut, which is brought into close contact with the open portions when the cutting direction is changed, can be naturally bent.

22. The anti-jam safety cutter of claim 21, wherein a multi-stepped portion, which is lowered from the plurality of obtusely-bent portions or round portions, is formed on the outer surface of the open portions of the first and second cutter body members, respectively, such that the object, which is brought into close contact with the open portions when the cutting direction is changed, can be naturally bent.
